(19) United States
(12) Patent Application Publication
(10) Pub. No.: US 2024/0204524 A1
(43) Pub. Date: Jun. 20, 2024

(54) BATTERY BANK POWER SYSTEM

(71) Applicant: Inventus Holdings, LLC, Juno Beach, FL (US)

(72) Inventors: Brady P. Drew, Lake Park, FL (US); Brandon W. Beisner, Loxahatchee, FL (US); Marc Benedict C. Tinio, Palm Beach Gardens, FL (US); Sabrena B. Gonzalez, Jupiter, FL (US); Vinicius F. Schuina, Jupiter, FL (US)

(21) Appl. No.: 18/080,819

(22) Filed: Dec. 14, 2022

(51) Int. Cl. H02J 3/32; H02J 7/00

(52) U.S. Cl. CPC H02J 3/32; H02J 7/0048; H02J 7/0063; H02J 7/00714; H02J 7/007182

(57) ABSTRACT

One example includes battery bank power system. The system includes a plurality of battery bank systems. Each of the battery bank systems can include a battery management system and a plurality of battery racks. Each of the battery racks can include a plurality of battery modules and each of the battery bank systems can be electrically connectable to an inverter bus. The system also includes an inverter that is electrically coupled to the inverter bus and is configured to provide an inverter current from the battery bank systems to a power grid in a discharging operation or to receive the inverter current from the power grid to the battery bank systems in a charging operation. The system further includes a battery system controller that is communicatively coupled to the battery management system of each of the battery bank systems to selectively control the battery bank systems.

### TECHNICAL FIELD

This disclosure relates generally to power systems, and more specifically to a battery bank power system.

### BACKGROUND

Battery storage technology is continuously being integrated into a power grid in a public utility or industrial power environment. A battery site may include multiple battery containers for storing and supplying electricity from and to the respective power grid. A battery container or battery bank can include multiple battery racks, with each battery rack including multiple battery modules that can store energy from and provide power to the power grid. Each battery container can be electrically connected to a respective inverter via a power bus, with the inverter being electrically connected to the power grid. A battery management system (BMS) can communicate with the inverter and can monitor characteristics associated with the battery racks to provide control of the charging of the battery modules from the power grid via the inverter and/or to provide control of the discharging of the battery modules to the power grid via the inverter.

### SUMMARY

One example includes a battery bank power system. The system includes a plurality of battery bank systems. Each of the battery bank systems can include a battery management system and a plurality of battery racks. Each of the battery racks can include a plurality of battery modules and each of the battery bank systems can be electrically connectable to an inverter bus. The system also includes an inverter that is electrically coupled to the inverter bus and is configured to provide an inverter current from the battery bank systems to a power grid in a discharging operation or to receive the inverter current from the power grid to the battery bank systems in a charging operation. The system further includes a battery system controller that is communicatively coupled to the battery management system of each of the battery bank systems to selectively control the battery bank systems.

Another example includes a method for controlling a battery bank power system. The method includes monitoring a voltage of each of a plurality of battery bank systems via a respective battery management system. Each of the battery bank systems can include contactors and a plurality of battery racks. Each of the battery racks can include a plurality of battery modules and each of the battery bank systems can be electrically coupled to an inverter bus associated with an inverter via the respective contactors. The method also includes providing the voltage of each of the battery bank systems from the battery management system of each of the respective battery bank systems to a battery system controller via a network. The method further includes selectively controlling the contactors associated with each of the battery bank systems to selectively electrically connect and disconnect the battery bank systems to the inverter bus based on a relative amplitude of the voltage of each of the battery bank systems to provide an inverter current from the battery bank systems to a power grid in a discharging operation or to receive the inverter current from the power grid to the battery bank systems in a charging operation.

Another example includes a battery bank power system. The system includes a plurality of battery bank systems. Each of the battery bank systems can include contactors, a battery management system and a plurality of battery racks. Each of the battery racks can include a plurality of battery modules and each of the battery bank systems can be electrically connectable to an inverter bus. The system also includes an inverter that is electrically coupled to the inverter bus and is configured to provide an inverter current from the battery bank systems to a power grid in a discharging operation or to receive the inverter current from the power grid to the battery bank systems in a charging operation. The system further includes a battery system controller that is communicatively coupled to the battery management system of each of the battery bank systems to selectively control the contactors of each of the battery bank systems based on a relative voltage of each of the battery bank systems.

### BRIEF DESCRIPTION OF THE DRAWINGS

FIG. 1 illustrates an example of a utility power system.

FIG. 2 illustrates an example block diagram of a battery power system.

FIG. 3 illustrates an example of a battery bank power system.

FIG. 4 illustrates an example of a method for controlling a battery bank power system.

### DETAILED DESCRIPTION

This disclosure relates generally to power systems, and more specifically to a battery bank power system. The battery bank power system can include a plurality of battery bank systems that are electrically coupled to the power grid. The battery bank systems can each correspond to a battery container. Each battery bank system includes a plurality of battery racks, with each of the battery racks including a plurality of battery modules. As described herein, each of the battery bank systems of the battery bank power system can be electrically coupled via respective contactors to a single inverter power conversion system (PCS), hereinafter “inverter”. The battery bank power system can thus receive power from the power grid via the inverter to charge the battery modules in a charging operation, and to provide power to the power grid via the inverter from the battery modules in a discharging operation.

Each of the battery bank systems can include a battery management system (BMS) that provides local control of the battery racks, contactors, and battery modules therein. Additionally, the battery bank power system can include a battery system controller that can communicate with the inverter and with each of the BMSs of the respective battery bank systems. The battery system controller can therefore selectively control the battery bank systems during each of the charging and discharging operations. For example, the battery system controller can selectively control the contactors of each of the battery bank systems to activate (close) the contactors to electrically connect the respective battery bank system to the inverter via a power bus, or to deactivate (open) the contactors to electrically disconnect the respective battery bank system from the inverter. As described in greater detail herein, the selective control of the contactors can be based on an external command provided from the battery system controller to the respective BMS of a given battery bank system, such that the BMS of the respective battery bank system can provide local control of the contactors to activate or deactivate all of the contactors associated with the respective battery bank system in response to the external command.

As an example, the BMS of each of the battery bank systems can monitor the voltage of the respective battery bank system. The battery system controller can thus monitor the voltage of each of the battery bank systems via the communications interface between the battery system controller and the BMSs. The battery system controller can thus prohibit activation of the contactors of a given battery bank system if the amplitude of the voltage of the battery bank system is outside of a predetermined threshold relative to the voltages of the other battery bank systems. As a result, the battery system controller can activate the contactors of the respective battery bank systems in a sequence based on voltage amplitudes of each of the battery bank systems based on the relative voltage amplitudes of the battery bank systems in each of the charging operation and discharging operation.

Furthermore, the battery system controller can be configured to implement additional control features in controlling the battery bank systems. For example, the battery system controller can be configured to reduce the bank current corresponding to the current provided between the inverter and the power grid to approximately zero before activation or deactivation of any of the contactors of the respective battery bank systems. As another example, the battery system controller can be configured to set a current limit for the bank current to and from the power grid based on the maximum current limits of each of the battery bank systems. For example, the battery system controller can set the limit for the bank current approximately equal to the lowest amplitude of the maximum threshold limits of the bank currents of the respective battery bank systems multiplied by the quantity of the battery bank systems having activated contactors.

The battery bank system can thus facilitate control of multiple battery bank systems operating with respect to a single inverter bus. Thus, significant cost savings and hardware space can be saved by the battery bank power system relative to a typical battery bank power system that implements a single battery bank system coupled to a single inverter. Accordingly, a typical battery power system would require significantly more inverters than a battery power system that includes the battery bank power systems described herein.

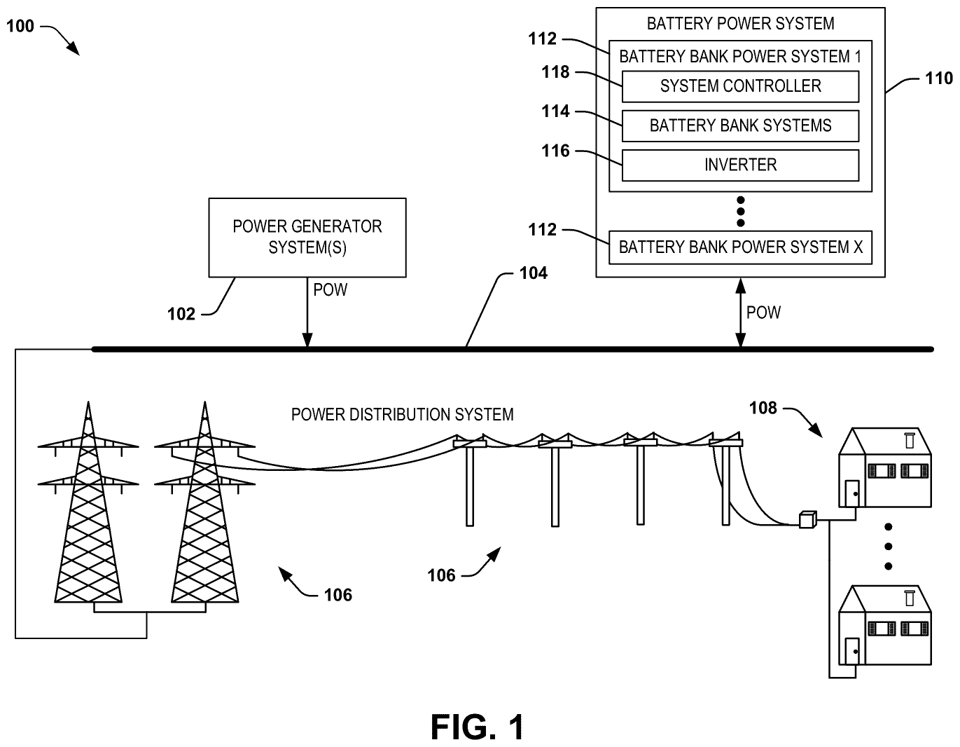

A battery power system can be implemented in any of a variety of utility power systems, such as demonstrated in the example of FIG. 1. FIG. 1 illustrates an example of a utility power system 100. The utility power system 100 includes at least one power generator system 102 that is configured to provide power, demonstrated in the example of FIG. 1 as POW, to a power grid 104. The power generator system(s) 102 can each correspond to any of a variety of power generator systems, such as fossil-fuel power generator systems, nuclear power generator systems, solar or wind power generator systems, etc. The power grid 104 can correspond to power buses and/or points-of-interconnect (POIs) that provide power via a power distribution system 106 (e.g., transformers, substations, and power lines) to consumers, demonstrated generally at 108.

The utility power system 100 also includes a battery power system 110 that is coupled to the power grid 104. In the example of FIG. 1, the battery power system 110 includes a plurality X of battery bank power systems 112, demonstrated as “BATTERY BANK SYSTEM 1” through “BATTERY BANK SYSTEM X”. Each of the battery bank power systems 112 is demonstrated as including a plurality of battery bank systems 114, an inverter 116, and a battery system controller (“SYSTEM CONTROLLER”) 118. Each of the battery bank systems 114 includes a plurality of battery racks, with each of the battery racks including a plurality of battery modules. Each of the battery bank systems 114 of each of the battery bank power systems 112 can be electrically coupled via respective contactors to a bus that is electrically coupled to the inverter 116. Each of the battery bank power systems 112 can thus receive power POW from the power grid 104 via the respective inverters 116 to charge the respective battery modules in a charging operation, and to provide power POW to the power grid 104 via the inverter 116 from the battery modules in a discharging operation.

Each of the battery bank systems 114 can include a battery management system (BMS) that provides local control of the battery racks and battery modules therein. Additionally, the battery system controller 118 of each of the battery bank power systems 112 can communicate with the respective inverter 116 and with each of the BMSs of the respective battery bank systems 114. The battery system controller 118 can therefore selectively control the battery bank systems 114 during each of the charging and discharging operations. For example, the battery system controller 118 can selectively control the contactors of each of the battery bank systems 114 to activate (close) the contactors to electrically connect the respective battery bank system 114 to the inverter 116 via the bus, or to deactivate (open) the contactors to electrically disconnect the respective battery bank system 114 from the inverter 116. As described herein, the control of the contactors by the battery system controller 118 can be based on the battery system controller 118 providing a command (e.g., over a network) to the BMS of the respective one of the battery bank systems 114 to activate (close) or deactivate (open) the contactors of the respective battery bank system 114.

As an example, the BMS of each of the battery bank systems 114 can monitor the voltage of the respective battery bank system 114. The battery system controller 118 can thus monitor the voltage of each of the battery bank systems 114 via the communications interface between the battery system controller 118 and the BMSs of the respective battery bank systems 114. The battery system controller 118 can thus prohibit activation of the contactors of a given battery bank system 114 if the amplitude of the voltage of the battery bank system 114 is outside of a predetermined threshold relative to the voltages of the other battery bank systems 114. As a result, the battery system controller 118 can activate the contactors of the respective battery bank systems 114 in a sequence based on voltage amplitudes of each of the battery bank systems 114 based on the relative voltage amplitudes of the battery bank systems 114 in each of the charging operation and discharging operation.

Furthermore, the battery system controller 118 can be configured to implement additional control features in controlling the battery bank systems 114. For example, the battery system controller 118 can be configured to reduce the bank current corresponding to the current provided between the inverter 116 and the power grid 104 to approximately zero before activation or deactivation of any of the contactors of the respective battery bank systems 114. As another example, the battery system controller 118 can be configured to set a current limit for the bank current to and from the power grid 104 based on the maximum current limits of each of the battery bank systems 114. As yet another example, the battery system controller 118 can selectively control the battery bank systems 114 based on monitoring fault information or by monitoring characteristics of each of the battery bank systems 114, such as upper and lower threshold limits associated with voltage, current, and/or state of charge (SOC).

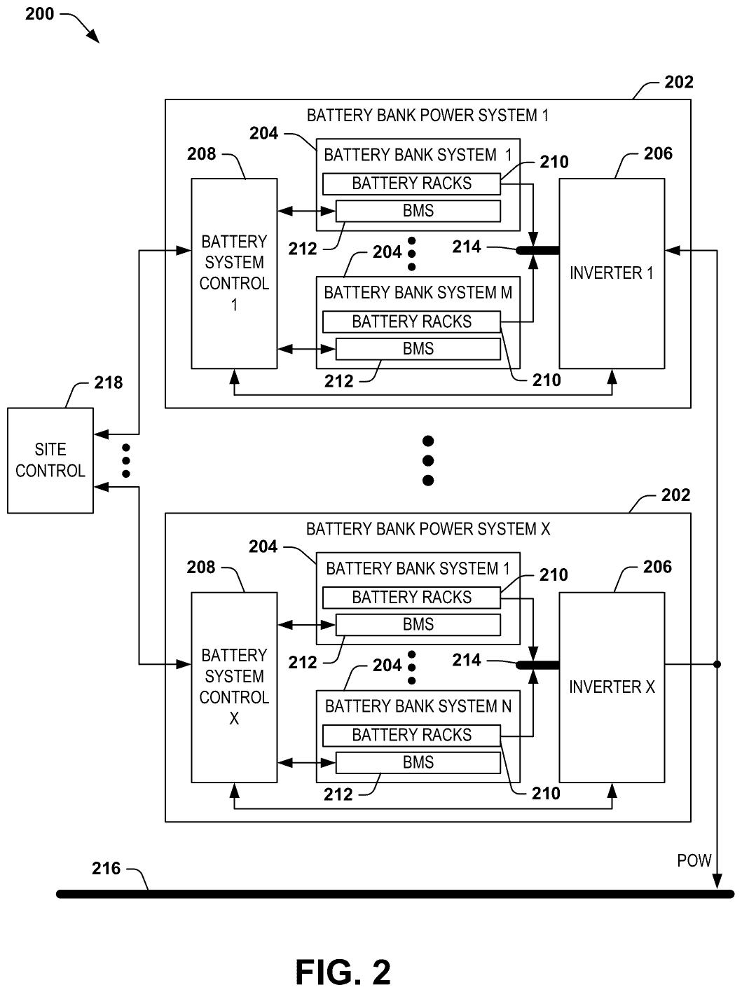

FIG. 2 illustrates an example block diagram of a battery power system 200. The battery power system 200 can correspond to the battery power system 110 in the example of FIG. 1. Therefore, reference is to be made to the example of FIG. 1 in the following description of the example of FIG. 2.

The battery power system 200 includes a plurality X of battery bank power systems 202, demonstrated as “BATTERY BANK SYSTEM” through “BATTERY BANK SYSTEM X”. Each of the battery bank power systems 202 is demonstrated as including a plurality of battery bank systems 204. In the example of FIG. 2, the first battery bank power system 202 is demonstrated as including a plurality M of battery bank systems 204, and the Xth battery bank power system 202 is demonstrated as including a plurality N of battery bank systems 204. Thus, the quantity of battery bank systems 204 is not necessarily the same in each of the battery bank power systems 202. Each of the battery bank power systems 202 also includes an inverter 206 and a battery system controller (“BATTERY SYSTEM CONTROL”) 208. As an example, the battery system controller 208 can be configured as a programmable logic controller (PLC) having a variety of configurable inputs and outputs (I/O). In the example of FIG. 2, each of the battery bank systems 204 includes a plurality of battery racks 210, with each of the battery racks 210 including a plurality of battery modules. Each of the battery bank systems 204 also includes a BMS 212 that provides local control of the battery racks 210 and the battery modules therein. Each of the battery bank systems 204 of each of the battery bank power systems 202 can be electrically coupled via a respective set of contactors to an inverter bus 214 that is coupled to the inverter 206. Each of the battery bank power systems 202 can thus receive power POW from the power grid 216 via the respective inverters 206 to charge the respective battery modules in a charging operation, and to provide power POW to the power grid 204 via the inverter 206 from the battery modules in a discharging operation.

The battery system controller 208 is demonstrated as communicatively coupled to the BMS 212 of each of the battery bank systems 204, and to the inverter 206 of the respective battery bank power system 202. The battery system controller 208 can therefore selectively control the battery bank systems 204 during each of the charging and discharging operations. For example, the battery system controller 208 can selectively control the contactors of each of the battery bank systems 204 to activate (close) the contactors to electrically connect the respective battery bank system 204 to the inverter 206 via the inverter bus 214, or to deactivate (open) the contactors to electrically disconnect the respective battery bank system 204 from the inverter bus 214, and thus the inverter 206. For example, the battery system controller 208 can providing a command (e.g., over a network) with the BMS 212 of the respective one of the battery bank systems 202 to activate (close) or deactivate (open) the contactors of the respective battery bank system 202. Additionally, in the example of FIG. 2, the battery system controller 208 is communicatively coupled to a site controller 218 that can correspond to a computer system that controls the entirety of the battery power system 200. As an example, the site controller 218 can correspond to a supervisory control and data acquisition (SCADA) system that can provide control and monitoring of the battery power system 200.

As an example, the BMS 212 of each of the battery bank systems 204 can monitor characteristics of the respective battery bank system 204. The characteristics can include voltage, high and low voltage limits, current, high and low current limits, SOC, high and low SOC limits, status conditions, faults, and/or a variety of other operational information regarding the respective battery bank system 204. As an example, in response to detecting a fault associated with any of the battery bank systems 204, as reported by the respective BMS 212, the battery system controller 208 can reduce the bank current corresponding to the current to or from the power grid 216 to approximately zero and can deactivate the contactors of each of the battery bank systems 204. As another example, the battery system controller 208 can detect that one of the battery bank systems 204 has a characteristic (e.g., voltage, current, or SOC) that has exceeded an upper or lower threshold limit, as reported by the respective BMS 212. Thus, the battery system controller 208 can deactivate the contactors of the respective battery bank system 204 while maintaining an activation state of the contactors of each of the other battery bank systems 204 in the battery bank power system 202.

As yet another example, the battery system controller 208 can monitor the voltage of each of the battery bank systems 204 via the communications interface between the battery system controller 208 and the BMSs 212 of the respective battery bank systems 204. The battery system controller 208 can define a voltage amplitude threshold that can provide for safe activation and deactivation of contactors of the battery bank systems 204, such as to mitigate current flow between battery bank systems 204 based on a large voltage imbalance. Therefore, the battery system controller 208 can prohibit activation of the contactors of a given battery bank system 204 if the amplitude of the voltage of the battery bank system 204 is outside of the predetermined threshold relative to the voltages of the other battery bank systems 204. As a result, the battery system controller 208 can activate the contactors of the respective battery bank systems 204 in a sequence based on the relative voltage amplitudes of the battery bank systems 204 in each of the charging operation and discharging operation. The sequence can, for example, correspond to activation of the contactors of each of the battery bank systems 204 in order from lowest voltage to highest voltage during the charging operation, and activation of the contactors of each of the battery bank systems 204 in order from highest voltage to lowest voltage during the discharging operation, as described in greater detail herein.

Furthermore, the battery system controller 208 can be configured to implement additional control features in controlling the battery bank systems 204. For example, the battery system controller 208 can be configured to reduce the bank current corresponding to the current provided between the inverter 206 and the power grid 216 to approximately zero before activation or deactivation of any of the contactors of the respective battery bank systems 204. As another example, the battery system controller 208 can be configured to set a current limit for the bank current to and from the power grid 204 based on the maximum current limits of each of the battery bank systems 204. For example, the battery system controller 208 can set the limit for the bank current approximately equal to the lowest amplitude of the maximum threshold limits of the bank currents of the respective battery bank systems 204 multiplied by the quantity of the battery bank systems 204 that are conductively coupled to the inverter bus 214 via the respective contactors.

While the battery power system 200 demonstrates that each of the battery bank power systems 202 includes a battery system controller 208, the battery power system 200 can include fewer than X battery system controllers 208. As an example, a given battery system controller 208 can provide control to more than one battery bank power system 202. As another example, a single battery system controller 208 can control all of the battery bank power systems 202 in the battery power system 200. As yet another example, the functionality of the battery system controller 208, as described herein, can be implemented by the site controller 218. Therefore, in this example, the site controller 218 can operate as the battery system controller 208 for each of the battery bank power systems 202.

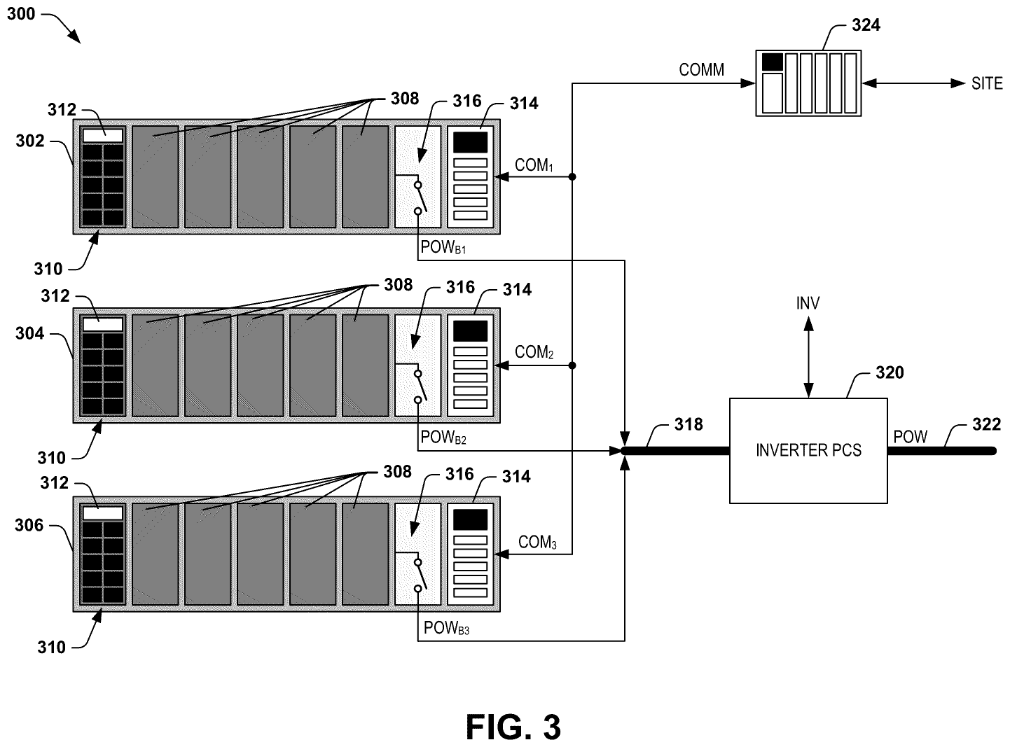

FIG. 3 illustrates an example of a battery bank power system 300. The battery bank power system 300 can correspond to any of the battery bank power systems 112 or 202 in the respective examples of FIGS. 1 and 2. Therefore, reference is to be made to the examples of FIGS. 1 and 2 in the following description of the example of FIG. 3.

The battery bank power system 300 includes a set of three battery bank systems, demonstrated as a first battery bank system 302, a second battery bank system 304, and third battery bank system 306. Each of the battery bank systems 302, 304, and 306 includes a plurality of battery racks 308, with each of the battery racks 308 including a plurality of battery modules. In the example of FIG. 3, each of the battery bank systems 302, 304, and 306 demonstrates an internal view of one of the battery racks 308 to reveal the battery modules therein, demonstrated as 310, as well as a rack BMS 312. The rack BMS 312 is configured to monitor and/or control the operation of the battery modules 310 in the respective one of the battery racks 308. Each of the battery bank systems 302, 304, and 306 also includes a BMS 314 that is configured to provide aggregate control of the battery racks 308. As an example, the BMS 314 can communicate with the rack BMSs 312 of each of the battery racks 308 to provide an upper layer of control of the battery bank system 302. Each of the battery bank systems 302, 304, and 306 further includes a set of contactors, demonstrated in the example of FIG. 3 as a contactor 316, that can be activated (closed) to electrically connect the battery racks 308, and thus the battery modules 310 of each of the battery racks 308, to a single inverter bus 318.

As described above, the contactor 316 can be representative of a set of multiple contactors of the respective one of the battery bank systems 302, 304, and 306. As an example, each of the battery bank systems 302, 304, and 306 can include multiple contactors, with each of the contactors being configured to connect or disconnect a respective one of the battery racks 308 to a parallel bus associated with the respective one of the battery bank systems 302, 304, and 306. The multiple contactors represented by the contactor 316 can be controlled by the respective BMS 312. Therefore, in the example of FIG. 3, the contactor 316 can be representative of a set of multiple contactors associated with the respective one of the battery bank systems 302, 304, and 306. Accordingly, the description of the state of the contactor 316 (e.g., with respect to being activated (closed) or deactivated (open)) can be representative of the state of all of the contactors represented thereby.

The battery bank power system 300 also includes an inverter 320 that is electrically coupled to the inverter bus 318. The inverter 320 can thus provide power POW from the battery bank systems 302, 304, and 306 to a power grid 322, or provide power POW to the battery bank systems 302, 304, and 306 from the power grid 322, based on the selective activation of the contactors 316 of the respective battery bank systems 302, 304, and 306. In the example of FIG. 3, the contribution of power provided from the first battery bank system 302 to the inverter bus 318 or received from the inverter bus 318 to the first battery bank system 302 is demonstrated as POW_{B1}. Similarly, the contribution of power provided from the second battery bank system 304 to the inverter bus 318 or received from the inverter bus 318 to the second battery bank system 304 is demonstrated as POW_{B2}. Similarly, the contribution of power provided from the third battery bank system 306 to the inverter bus 318 or received from the inverter bus 318 to the third battery bank system 306 is demonstrated as POW_{B3}.

The battery bank power system 300 further includes a battery system controller 324. As an example, the battery system controller 324 can be configured as a PLC having a variety of configurable I/O. The battery system controller 324 is communicatively coupled to each of the BMSs 314 of the respective battery bank systems 302, 304, and 306. In the example of FIG. 3, the BMS 314 of the first battery bank system 302 provides communications COM₁ to and from the battery system controller 324, the BMS 314 of the second battery bank system 304 provides communications COM₂ to and from the battery system controller 324, and the BMS 314 of the third battery bank system 306 provides communications COM₃ to and from the battery system controller 324, with the aggregate communications being demonstrated as COMM. Additionally, in the example of FIG. 3, the battery system controller 324 can provide bidirectional communication SITE to a site controller, such as the site controller 218 in the example of FIG. 2. The communications provided to and from the BMSs 314 and/or the site controller can be provided on a network, such as via Ethernet.

As described herein, the battery system controller 324 can control the contactor 316 of each of the battery bank systems 302, 304, and 306. For example, the battery system controller 324 can provide an activation command or a deactivation command via the communications COMM to a respective one of the battery bank systems 302, 304, and 306. In response to the activation or deactivation command, the BMS 312 of the respective one of the battery bank systems 302, 304, and 306 can provide a local command to respectively close or open the contactor 316 (e.g., all of the contactors) of the respective one of the battery bank systems 302, 304, and 306. Therefore, as described below, activation and deactivation of the contactor 316 of the battery bank systems 302, 304, and 306 can be based on the communications COMM between the battery system controller 324 and the BMSs 312 of the respective battery bank systems 302, 304, and 306.

As an example, the BMS 314 of each of the battery bank systems 302, 304, and 306 can monitor characteristics of the respective one of the battery bank systems 302, 304, and 306. The characteristics can include voltage, high and low voltage limits, current, high and low current limits, SOC, high and low SOC limits, status conditions, faults, and/or a variety of other operational information regarding the respective one of the battery bank systems 302, 304, and 306. The characteristics can thus be communicated to the battery system controller 324 via the respective communications COM₁, COM₂, and COM₃. As an example, in response to detecting a fault associated with any of the battery bank systems 302, 304, and 306, as reported by the respective BMS 314, the battery system controller 324 can reduce the bank current corresponding to the current to or from the power grid 322 to approximately zero and can deactivate the contactor 316 of each of the battery bank systems 302, 304, and 306. As another example, the battery system controller 324 can similarly reduce the bank current corresponding to the current to or from the power grid 322 to approximately zero and can deactivate the contactor 316 of each of the battery bank systems 302, 304, and 306 in response to detecting a communications loss of the communications COMM, such as after expiration of a predetermined watchdog timer. As yet another example, the battery system controller 324 can detect that one of the battery bank systems 302, 304, and 306 has a characteristic (e.g., voltage, current, or SOC) that has exceeded an upper or lower threshold limit, as reported by the respective BMS 314. Thus, the battery system controller 324 can deactivate (open) the contactor 316 of the respective one of the battery bank systems 302, 304, and 306 while maintaining an activation state of the contactor 316 of one or both of the other battery bank systems 302, 304, and 306 in the battery bank power system 300.

As yet another example, the battery system controller 324 can monitor the voltage of each of the battery bank systems 302, 304, and 306 via the communications interfaces COMM between the battery system controller 324 and the BMSs 314 of the respective battery bank systems 302, 304, and 306. The battery system controller 324 can define a voltage amplitude threshold (e.g., approximately ten volts) that can provide for safe activation and deactivation of contactors 316 of the battery bank systems 302, 304, and 306, such as to mitigate current flow between battery bank systems 302, 304, and 306 based on a large voltage imbalance. Therefore, the battery system controller 324 can prohibit activation of the contactor 316 of a given one of the battery bank systems 302, 304, and 306 if the amplitude of the voltage of the one of the battery bank systems 302, 304, and 306 is outside of the predetermined threshold relative to the voltages of the other battery bank systems 302, 304, and 306.

The battery system controller 324 can therefore selectively control the battery bank systems 302, 304, and 306 during each of the charging and discharging operations. As an example, the battery system controller 324 can activate the contactors 316 of the respective battery bank systems 302, 304, and 306 in a sequence based on the relative voltage amplitudes of the battery bank systems 302, 304, and 306 in each of the charging operation and discharging operation. The sequence can, for example, correspond to activation of the contactor 316 of each of the battery bank systems 302, 304, and 306 in order from lowest voltage to highest voltage during the charging operation, and activation of the contactor 316 of each of the battery bank systems 302, 304, and 306 in order from highest voltage to lowest voltage during the discharging operation.

As a first example, the battery system controller 324 can determine that the voltage of each of the battery bank systems 302 can be within the predetermined threshold. For example, the first battery bank system 302 can have a voltage of approximately 1501 volts, the second battery bank system 304 can have a voltage of approximately 1500 volts, and the third battery bank system 306 can have a voltage of approximately 1497 volts, with a predetermined threshold amplitude of approximately 10 volts. In this example, the battery system controller 324 can determine that the battery bank systems 302, 304, and 306 can implement a balanced start. Therefore, the battery system controller 324 can activate (close) the contactors 316 of each of the battery bank systems 302, 304, and 306 approximately concurrently, or in a sequence (e.g., in an open loop manner) in either of the charging or discharging operations.

As a second example, the battery system controller 324 can determine that the voltage of one of the battery bank systems 302 can be outside of the predetermined threshold. For example, the first battery bank system 302 can have a voltage of approximately 1410 volts, the second battery bank system 304 can have a voltage of approximately 1408 volts, and the third battery bank system 306 can have a voltage of approximately 1460 volts, with a predetermined threshold amplitude of approximately 10 volts. In this example, the battery system controller 324 can determine that the battery bank systems 302, 304, and 306 are imbalanced, with one of the battery bank systems 302, 304, and 306 being greater than the other two. During a discharging operation, the battery system controller 324 can activate (close) the contactor 316 of the third battery bank system 306 first to discharge the third battery bank system 306. The battery system controller 324 can continue to monitor the voltages of the battery bank systems 302, 304, and 306, such that, upon determining that the voltage of the third battery bank system 306 has decreased to within the predetermined threshold amplitude relative to the first and second battery bank systems 302 and 304, the battery system controller 324 can activate (close) the contactors 316 of the first and second battery bank systems 302 and 304 approximately concurrently to provide discharging from all three of the battery bank systems 302, 304, and 306. Conversely, during a charging operation, the battery system controller 324 can activate (close) the contactors 316 of the first and second battery bank systems 302 and 304 first to charge the first and second battery bank systems 302 and 304. The battery system controller 324 can continue to monitor the voltages of the battery bank systems 302, 304, and 306, such that, upon determining that the voltage of the first and second battery bank systems 302 and 304 has increased to within the predetermined threshold amplitude relative to the third battery bank system 306, the battery system controller 324 can activate (close) the contactor 316 of the third battery bank system 306 approximately concurrently to provide charging of all three of the battery bank systems 302, 304, and 306.

As a third example, the battery system controller 324 can determine that the voltage of one of the battery bank systems 302 can be outside of the predetermined threshold. For example, the first battery bank system 302 can have a voltage of approximately 1460 volts, the second battery bank system 304 can have a voltage of approximately 1461 volts, and the third battery bank system 306 can have a voltage of approximately 1401 volts, with a predetermined threshold amplitude of approximately 10 volts. In this example, the battery system controller 324 can determine that the battery bank systems 302, 304, and 306 are imbalanced, with one of the battery bank systems 302, 304, and 306 being less than the other two. During a discharging operation, the battery system controller 324 can activate (close) the contactors 316 of the first and second battery bank systems 302 and 304 first to discharge the first and second battery bank systems 302 and 304. The battery system controller 324 can continue to monitor the voltages of the battery bank systems 302, 304, and 306, such that, upon determining that the voltage of the first and second battery bank systems 302 and 304 has decreased to within the predetermined threshold amplitude relative to the third battery bank system 306, the battery system controller 324 can activate (close) the contactor 316 of the third battery bank system 306 approximately concurrently to provide discharging of all three of the battery bank systems 302, 304, and 306. Conversely, during a charging operation, the battery system controller 324 can activate (close) the contactor 316 of the third battery bank system 306 first to charge the third battery bank system 306. The battery system controller 324 can continue to monitor the voltages of the battery bank systems 302, 304, and 306, such that, upon determining that the voltage of the third battery bank system 306 has increased to within the predetermined threshold amplitude relative to the first and second battery bank systems 302 and 304, the battery system controller 324 can activate (close) the contactors 316 of the first and second battery bank systems 302 and 304 approximately concurrently to provide charging to all three of the battery bank systems 302, 304, and 306.

As a fourth example, the battery system controller 324 can determine that the voltages of all of the battery bank systems 302 are outside of the predetermined threshold relative to each other. For example, the first battery bank system 302 can have a voltage of approximately 1501 volts, the second battery bank system 304 can have a voltage of approximately 1460 volts, and the third battery bank system 306 can have a voltage of approximately 1401 volts, with a predetermined threshold amplitude of approximately 10 volts. In this example, the battery system controller 324 can determine that the battery bank systems 302, 304, and 306 are completely imbalanced. During a discharging operation, the battery system controller 324 can activate (close) the contactor 316 of the first battery bank system 302 first to discharge the first battery bank system 302. The battery system controller 324 can continue to monitor the voltages of the battery bank systems 302, 304, and 306, such that, upon determining that the voltage of the first battery bank system 302 has decreased to within the predetermined threshold amplitude relative to the second battery bank system 304, the battery system controller 324 can activate (close) the contactor 316 of the second battery bank system 304. Upon determining that the voltages of the first and second battery bank systems 302 and 304 have decreased to within the predetermined threshold amplitude relative to the third battery bank system 306, the battery system controller 324 can activate (close) the contactor 316 of the third battery bank system 306 to provide discharging of all three of the battery bank systems 302, 304, and 306. Conversely, during a charging operation, the battery system controller 324 can activate (close) the contactor 316 of the third battery bank system 306 first to charge the third battery bank system 306. The battery system controller 324 can continue to monitor the voltages of the battery bank systems 302, 304, and 306, such that, upon determining that the voltage of the third battery bank system 306 has increased to within the predetermined threshold amplitude relative to the second battery bank system 304, the battery system controller 324 can activate (close) the contactor 316 of the second battery bank system 304. Upon determining that the voltage of the second and third battery bank systems 304 and 306 has increased to within the predetermined threshold amplitude relative to the first battery bank system 302, the battery system controller 324 can activate (close) the contactor 316 of the first battery bank system 302 to provide charging to all three of the battery bank systems 302, 304, and 306.

Furthermore, the battery system controller 324 can be configured to implement additional control features in controlling the battery bank systems 302, 304, and 306, as well as the inverter 320. In the example of FIG. 3, the inverter 320 is demonstrated as receiving communicating over a network (e.g., the network to which the battery system controller 324 and the associated site controller are coupled) via communications INV, such as providing a communication link to the site controller. For example, the battery system controller 324 can be configured to command the inverter 320 by providing commands to the site controller via the communications SITE, such that via the site controller can provide communications INV to the inverter 320 to provide control functions. In this manner, the battery system controller 324 can provide control signals indirectly to the inverter 320 (e.g., through the site controller). Alternatively, the battery system controller 324 can provide direct commands to the inverter 320 over the associated network on which the communications INV are provided.

For example, the battery system controller 324 can provide a command via the communications INV to reduce a bank current corresponding to the current provided between the inverter 320 and the power grid 322 to approximately zero before activation or deactivation of any of the contactors 316 of the respective battery bank systems 302, 304, and 306. As another example, the battery system controller 324 can be configured to set a current limit for the bank current to and from the power grid 322 based on the maximum current limits of each of the battery bank systems 302, 304, and 306 via the communications INV. For example, the battery system controller 324 can set the limit for the bank current approximately equal to the lowest amplitude of the maximum threshold limits of the bank currents of the respective battery bank systems 302, 304, and 306 multiplied by the quantity of the battery bank systems 302, 304, and 306 that are conductively coupled to the inverter bus 318 via the respective contactors 316. The current limit can be set at the inverter 320 via the communications INV, and can be continuously updated in real-time based on the activation conditions and continuously monitored current limits of the battery bank systems 302, 304, and 306. Furthermore, the battery system controller 324 can facilitate manual control of the battery bank systems 302, 304, and 306 and the inverter 320, which could additionally be done from the site controller, as described above, such as during troubleshooting or initial operating conditions.

Therefore, as described above, the battery system controller 324 can facilitate control of multiple battery bank systems to provide power to and receive power from a single inverter 320. While the example of FIG. 3 provides for three battery bank systems 302, 304, and 306, a battery bank power system could instead include only two battery bank systems, or could have more than three battery bank systems. The control mechanisms implemented by the battery system controller 324 can provide for effective and efficient charging and discharging of the multiple battery bank systems in a safe manner. Typical battery bank power systems include a single inverter bus for each single battery bank system, such that considerations of imbalanced voltages and characteristics of multiple battery bank systems need not be accounted for. However, by operating a single inverter bus for multiple battery bank systems, as described herein, significant cost and space savings can be achieved relative to a typical battery bank power system by obviating the need for multiple inverters. Accordingly, the battery bank power system described herein can provide a significant improvement over conventional battery bank power systems.

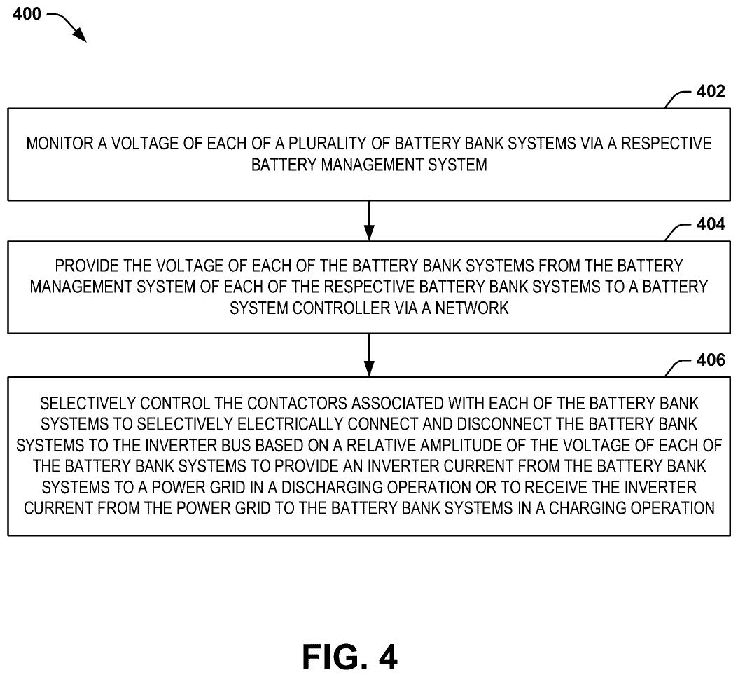

In view of the foregoing structural and functional features described above, methods in accordance with various aspects of the present disclosure will be better appreciated with reference to FIG. 4. While, for purposes of simplicity of explanation, the method of FIG. 4 is shown and described as executing serially, it is to be understood and appreciated that the present disclosure is not limited by the illustrated orders, as some aspects could, in accordance with the present disclosure, occur in different orders and/or concurrently with other aspects from that shown and described herein. Moreover, not all illustrated features may be required to implement method in accordance with an aspect of the present disclosure.

FIG. 4 illustrates a method 400 for controlling a battery bank power system (e.g., the battery bank power system 300). At 402, a voltage of each of a plurality of battery bank systems (e.g., the battery bank systems 302, 304, 306) is monitored via a respective battery management system (e.g., the BMSs 314). Each of the battery bank systems can include contactors (e.g., the contactor 316) and a plurality of battery racks (e.g., the battery racks 308). Each of the battery racks can include a plurality of battery modules (e.g., the battery modules 310) and each of the battery bank systems can be electrically coupled to an inverter bus (e.g., the inverter bus 318) associated with an inverter (e.g., the inverter 320) via the respective contactors. At 404, the voltage of each of the battery bank systems is provided from the battery management system of each of the respective battery bank systems to a battery system controller (e.g., battery system controller 324) via a network (e.g., the communications COMM). At 406, the contactors associated with each of the battery bank systems are selectively controlled to selectively electrically connect and disconnect the battery bank systems to the inverter bus based on a relative amplitude of the voltage of each of the battery bank systems to provide an inverter current from the battery bank systems to a power grid (e.g., the power grid 322) in a discharging operation or to receive the inverter current from the power grid to the battery bank systems in a charging operation.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A battery bank power system comprising:
a plurality of battery bank systems, each of the battery bank systems comprising a battery management system and a plurality of battery racks, each of the battery racks comprising a plurality of battery modules and each of the battery bank systems being electrically connectable to an inverter bus;
an inverter that is electrically coupled to the inverter bus and is configured to provide an inverter current from the battery bank systems to a power grid in a discharging operation or to receive the inverter current from the power grid to the battery bank systems in a charging operation; and
a battery system controller that is communicatively coupled to the battery management system of each of the battery bank systems to selectively control the battery bank systems.

2. The system of claim 1, wherein each of the battery bank systems comprises contactors that are activated by the battery system controller to electrically connect the respective one of the battery bank systems to the inverter bus and is deactivated by the battery system controller to electrically disconnect the respective one of the battery bank systems from the inverter bus.

3. The system of claim 2, wherein the battery management system of each of the respective battery bank systems is configured to monitor a voltage associated with the respective one of the battery bank systems, wherein the battery system controller is configured to receive the voltage associated with each of the battery bank systems and to selectively control activation and deactivation of the contactors of each of the battery bank systems based on a threshold amplitude associated with relative voltage of each of the battery bank systems.

4. The system of claim 3, wherein the battery system controller is configured to prohibit activation of the contactors of a respective one of the battery bank systems in response to the voltage of the respective one of the battery bank systems being outside of a predetermined threshold amplitude relative to at least one other battery bank system during the charging operation or the discharging operation.

5. The system of claim 4, wherein the battery system controller is configured to selectively activate the contactors of each of battery bank systems in a sequence in response to the voltage of at least one of the battery bank systems being outside of the predetermined threshold amplitude at a beginning of the charging operation or the discharging operation.

6. The system of claim 5, wherein the sequence comprises activation of the contactors of each of the battery bank systems in order from lowest voltage to highest voltage during the charging operation, and activation of the contactors of each of the battery bank systems in order from highest voltage to lowest voltage during the discharging operation.

7. The system of claim 6, wherein the battery system controller is configured to activate a respective one of the battery bank systems in the sequence in response to the voltage of the respective one of the battery bank systems being within the threshold amplitude of the preceding one of the battery bank systems in the sequence.

8. The system of claim 2, wherein the battery system controller is configured to reduce the inverter current provided to or from the inverter to approximately zero before activation or deactivation of the contactors of each of battery bank systems.

9. The system of claim 2, wherein the battery system controller is configured to monitor a bank voltage, a bank current, and a bank state-of-charge (SOC) associated with each of the battery bank systems, and is further configured to deactivate the contactors of a respective one of the battery bank systems in response to detecting that one of the bank voltage, the bank current, and the bank SOC of the respective has exceeded a threshold limit.

10. The system of claim 9, wherein the battery system controller is configured to continuously set a limit for the inverter current provided to and received by the inverter, the limit being approximately equal to a lowest amplitude of a maximum threshold limit of the bank current of the battery bank systems multiplied by a quantity of the battery bank systems having activated contactors.

11. The system of claim 1, wherein the battery system controller is configured to reduce the inverter current provided to or from the inverter to approximately zero in response to detecting a fault associated with the battery management system associated with each of the battery bank systems or a communication disconnect between the battery system controller and the battery management system associated with each of the battery bank systems.

12. A method for controlling a battery bank power system, the method comprising:
monitoring a voltage of each of a plurality of battery bank systems via a respective battery management system, each of the battery bank systems comprising contactors and a plurality of battery racks, each of the battery racks comprising a plurality of battery modules and each of the battery bank systems being electrically coupled to an inverter bus associated with an inverter via the respective contactors;
providing the voltage of each of the battery bank systems from the battery management system of each of the respective battery bank systems to a battery system controller via a network; and
selectively controlling the contactors associated with each of the battery bank systems to selectively electrically connect and disconnect the battery bank systems to the inverter bus based on a relative amplitude of the voltage of each of the battery bank systems to provide an inverter current from the battery bank systems to a power grid in a discharging operation or to receive the inverter current from the power grid to the battery bank systems in a charging operation.

13. The method of claim 12, wherein selectively controlling the contactors associated with each of the battery bank systems comprises prohibiting activation of the contactors of a respective one of the battery bank systems in response to the voltage of the respective one of the battery bank systems being outside of a predetermined threshold amplitude relative to at least one other battery bank system during the charging operation or the discharging operation.

14. The method of claim 13, wherein selectively controlling the contactors associated with each of the battery bank systems comprises selectively activating the contactors of each of battery bank systems in a sequence in response to the voltage of at least one of the battery bank systems being outside of the predetermined threshold amplitude at a beginning of the charging operation or the discharging operation, wherein the sequence comprises activation of the contactors of each of the battery bank systems in order from lowest voltage to highest voltage during the charging operation, and activation of the contactors of each of the battery bank systems in order from highest voltage to lowest voltage during the discharging operation.

15. The method of claim 14, wherein selectively activating the contactors of each of battery bank systems comprises activating a respective one of the battery bank systems in the sequence in response to the voltage of the respective one of the battery bank systems being within a threshold amplitude associated with relative voltage of the preceding one of the battery bank systems in the sequence.

16. A battery bank power system comprising:
a plurality of battery bank systems, each of the battery bank systems comprising contactors, a battery management system, and a plurality of battery racks, each of the battery racks comprising a plurality of battery modules and each of the battery bank systems being electrically connectable to an inverter bus;
an inverter that is electrically coupled to the inverter bus and is configured to provide an inverter current from the battery bank systems to a power grid in a discharging operation or to receive the inverter current from the power grid to the battery bank systems in a charging operation; and
a battery system controller that is communicatively coupled to the battery management system of each of the battery bank systems to selectively control the contactors of each of the battery bank systems based on a relative voltage of each of the battery bank systems.

17. The system of claim 16, wherein the battery system controller is configured to prohibit activation of the contactors of a respective one of the battery bank systems in response to the voltage of the respective one of the battery bank systems being outside of a predetermined threshold amplitude relative to at least one other battery bank system during the charging operation or the discharging operation.

18. The system of claim 17, wherein the battery system controller is configured to selectively activate the contactors of each of battery bank systems in a sequence in response to the voltage of at least one of the battery bank systems being outside of the predetermined threshold amplitude at a beginning of the charging operation or the discharging operation.

19. The system of claim 18, wherein the sequence comprises activation of the contactors of each of the battery bank systems in order from lowest voltage to highest voltage during the charging operation, and activation of the contactors of each of the battery bank systems in order from highest voltage to lowest voltage during the discharging operation.

20. The system of claim 19, wherein the battery system controller is configured to activate a respective one of the battery bank systems in the sequence in response to the voltage of the respective one of the battery bank systems being within a threshold amplitude associated with relative voltage of the preceding one of the battery bank systems in the sequence.
